(19) United States
(12) Patent Application Publication
(10) Pub. No.: US 2016/0216418 A1
(43) Pub. Date: Jul. 28, 2016

(54) WELD OBSERVATION DEVICE

(71) Applicant: Brandi Tafoya, Denver, CO (US)

(72) Inventor: Brandi Tafoya, Denver, CO (US)

(21) Appl. No.: 15/007,050

(22) Filed: Jan. 26, 2016

Related U.S. Application Data
(60) Provisional application No. 62/108,285, filed on Jan. 27, 2015.

(51) Int. Cl. G02B 5/26; G02B 7/00; F16P 1/06; G02B 5/20

(52) U.S. Cl. CPC G02B 5/26; G02B 5/208; G02B 7/006; F16P 1/06

(57) ABSTRACT

In one embodiment, a weld observation device comprises a panel of tinted glass, a frame, a mount, a hinge and a stop bracket. The panel may be elongate in the horizontal direction. The frame may be secured to at least a portion of perimeter of the panel of tinted glass. The upper surface of the mount may be rotatably secured to a bottom edge of the frame via the lunge. The stop bracket may be attached to the frame such that rotation of the hinge in a first direction is arrested by the stop bracket contacting the upper surface of the mount.

### CROSS REFERENCE TO RELATED APPLICATIONS

This application claims priority to copending U.S. Application Ser. No. 62/108,285, filed on Jan. 27 2015, which is hereby incorporated by reference for all purposes.

### BACKGROUND

The present disclosure relates generally to welding safety devices. In particular, welding eye protection devices are described.

Known eye protection devices are not entirely satisfactory for the range of applications in which they are employed. For example, existing welding masks are heavy and must be supported by a user's head. In addition, conventional welding masks make it difficult for the wearer to speak and to hear others speaking.

Thus, there exists a need for welding eye protection devices that improve upon and advance the design of known devices. Examples of new and useful welding eye protection devices relevant to the needs existing in the field are discussed below.

### SUMMARY

In one embodiment, a weld observation device comprises a panel of tinted glass, a frame, a mount, a hinge and a stop bracket. The panel may be elongate in the horizontal direction. The frame max be secured to at least a portion of perimeter of the panel of tinted glass. The upper surface of the mount may be rotatable secured to a bottom edge of the frame via the hinge. The stop bracket may be attached to the frame such that rotation of the hinge in a first direction is arrested by the stop bracket contacting the upper surface of the mount.

In another embodiment, a weld observation device comprises a panel of tinted glass, a frame, a mount, a caster and a vertical rail. The panel may be elongate in the horizontal direction. The frame may be secured to at least a portion of perimeter of the panel of tinted glass. The caster may be attached to a rear face of the frame. The vertical rail may slide ably retain the caster. The rail may be attached to the front face of the first mount.

In still an embodiment, a weld observation device comprises a panel of tinted glass, a frame, a mount, and a pivot arm. The panel may be elongate in the horizontal direction. The frame may be secured to at least a portion of perimeter of the panel of tinted glass. The upper surface of the mount may rotatably secured to a side edge of the frame via the pivot arm.

### BRIEF DESCRIPTION OF THE DRAWINGS

FIG. 1 is a perspective view of a first embodiment of a weld observation device.

FIG. 2 is a perspective view of the weld observation device shown in FIG. 1 depicting the hinge in operation.

FIG. 3 is a side elevation view of the weld observation device shown in FIG. 1.

FIG. 4 is a top plan view of a second embodiment of a weld observation device comprising a rail.

FIG. 5 a side elevation view of the weld observation device of FIG. 4.

FIG. 6 is a perspective view third embodiment of weld observation device comprising a pair of pivot arms.

FIG. 7 is a side elevation view of the weld observation device of FIG. 6, showing the glass panel in a retracted position.

FIG. 8 is a side elevation view of the weld observation device of FIG. 6, showing the glass panel in a partially extended position.

FIG. 9 is a side elevation view of the weld observation device of FIG. 6, showing the glass panel in a completely extended position.

### DETAILED DESCRIPTION

The disclosed weld observation devices will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and ever contemplated variation is not individually described in the following detailed description.

Throughout the following detailed description, examples of various weld observation devices are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

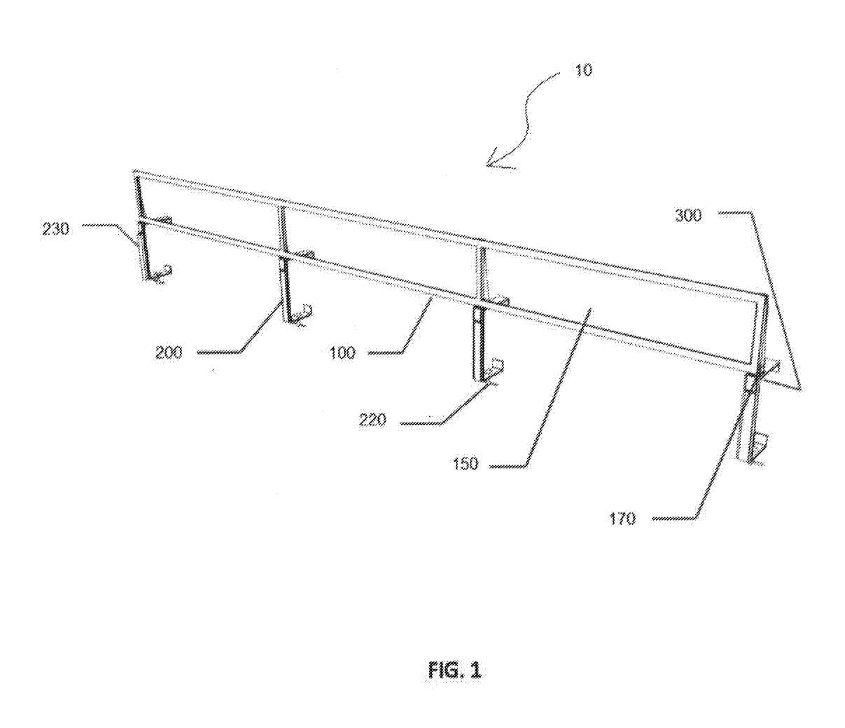

With reference to FIGS. 1-3, a first example of a weld observation device, weld observation device 10, will now be described. Weld observation device 10 functions to protect the user's eyes, face and neck from flash burn, ultraviolet light, sparks, infrared light, and/or heat white operating a welding machine. The reader will appreciate from the figures and description below that weld observation device 10 addresses shortcomings of conventional eye protection.

For example, weld observation device 10 can be attached to a welding machine, thus the user is not burdened by a heavy welding mask. Furthermore, weld observation device 10 allows the user to speak and to hear others speaking.

Weld observation device 10 comprises a panel of tinted glass 150, a frame 100 attached to a plurality of mounts 200 via hinges 300, and at least one stop bracket 170.

As can be seen in FIG. 1, the panel of tinted glass 150 may be elongate in the horizontal direction. As described below, weld observation device 10 may be attached to a welding machine, such as a horizontal seem welding machine. In some embodiments, the horizontally elongate shape of panel 150 may facilitate safe viewing of the welding machine as it traverses the entire length of a seem weld.

The panel 150 of tinted glass may be tinted to reflect at least some potentially harmful electromagnetic radiation (e.g., ultra-violet and/or infrared radiation). In one embodiment, the tinted glass is tinted to an ANSI welding shade number of from 3 to 14. In other embodiments, the tinted glass is tinted to an ANSI welding shade number of from 5 to 13. In still other embodiments, the tinted glass is tinted to an ANSI welding shade number of from 7 to 11. In other embodiments, the tinted glass is tinted to an ANSI welding shade number of from 8 to 10.

As shown in FIG. 1, the panel of tinted glass 150 may be secured via a frame 100. Frame 100 may be secured to at least a portion of the perimeter of the panel 150. Furthermore, the frame 100 may comprise vertical cross members spaced apart from each other to provide additional rigidity.

In the illustrated embodiment, frame 100 comprises metal (e.g., stainless steel, carbon steel, aluminum, among others). In other embodiments, frame 100 may comprise other suit le materials such as plastic, wood, and/or carbon fiber, or other composites.

As shown in FIG. 1, a bottom edge of frame 100 is attached to one or more mounts 200. Mount 200 functions to attach weld observation device 10 to a welding machine (not pictured). In the illustrated embodiment, mourn 200 comprises a clamp including a lower clamping jaw spaced apart from an upper clamping jaw. In other embodiments, mount 200 may comprise holes configured to mate with fasteners (e.g., threaded fasteners) and corresponding holes on the welding machine.

Mount 200 may further comprise a clamping piston 220. In the illustrated embodiment, clamping piston operates via threads. In other embodiments, clamping piston may operate via cams and levers, or via other suitable mechanical means. Thus, mount 200 may be configured to attach weld observation device 10 to a rail or table of a welding machine.

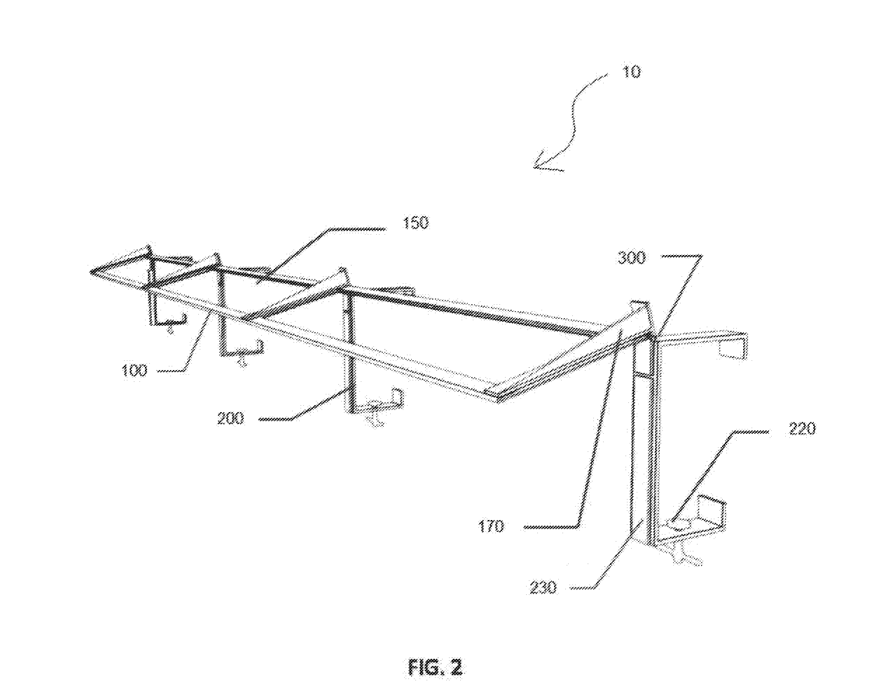

As shown in FIG. 2, mount 200 may be attached to frame 100 via a hinge 300. In the illustrated embodiment, hinge 300 is attached to mount 200 at an upper surface of mount 200. Hinge 300 functions to allow frame 100 and tinted glass panel 150 to be rotated out of the way, for vie to provide access to the welding machine.

In this regard, mount 200 may include a pad 230 attached to a front surface of mount 200. Thus, downward rotation of frame 100 and tinted glass panel 150 may be arrested when frame 100 contacts pad 230.

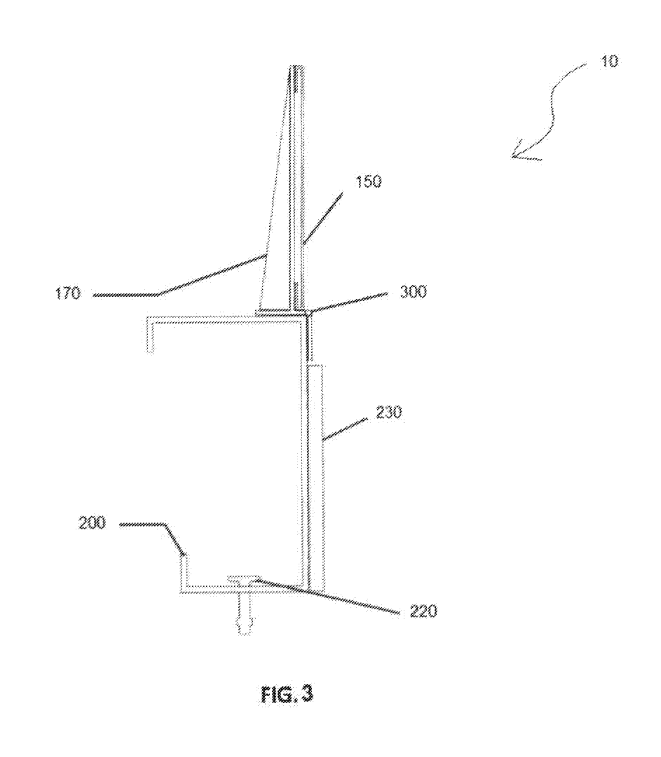

As shown in FIG. 3, a stop bracket 170 may be attached to the back side of frame 100. Stop bracket 170 functions to arrest upward rotation of the hinge and hold the frame 100 in an upright position. As can be seen in FIG. 2, stop bracket 170 includes a bottom surface configured to contact the upper surface of mount 200, thereby arresting upward rotation of frame 100 and tinted glass panel 150 when the bottom surface of stop bracket 170 contacts the upper surface of the mount 200.

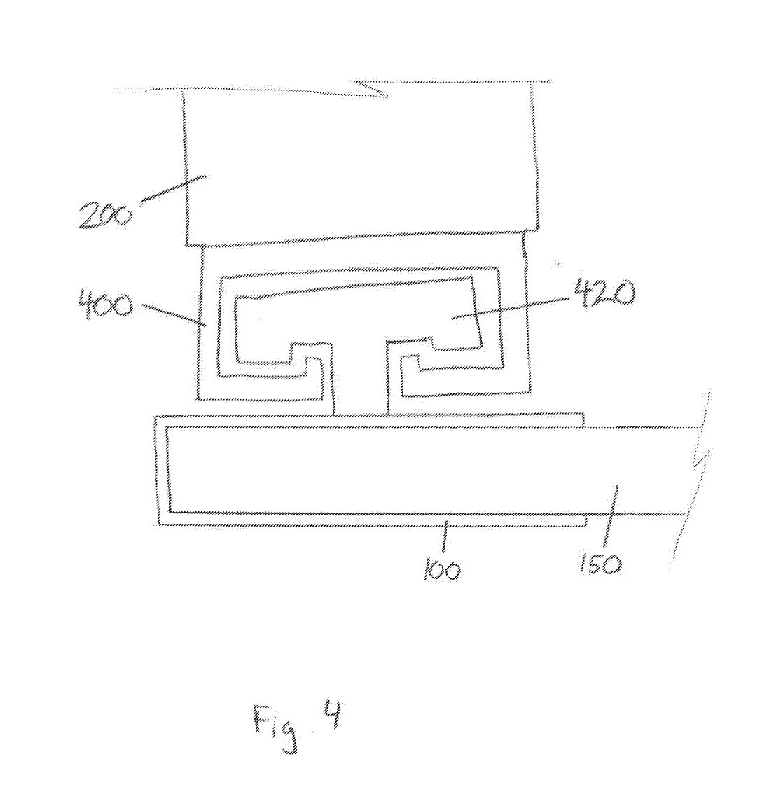

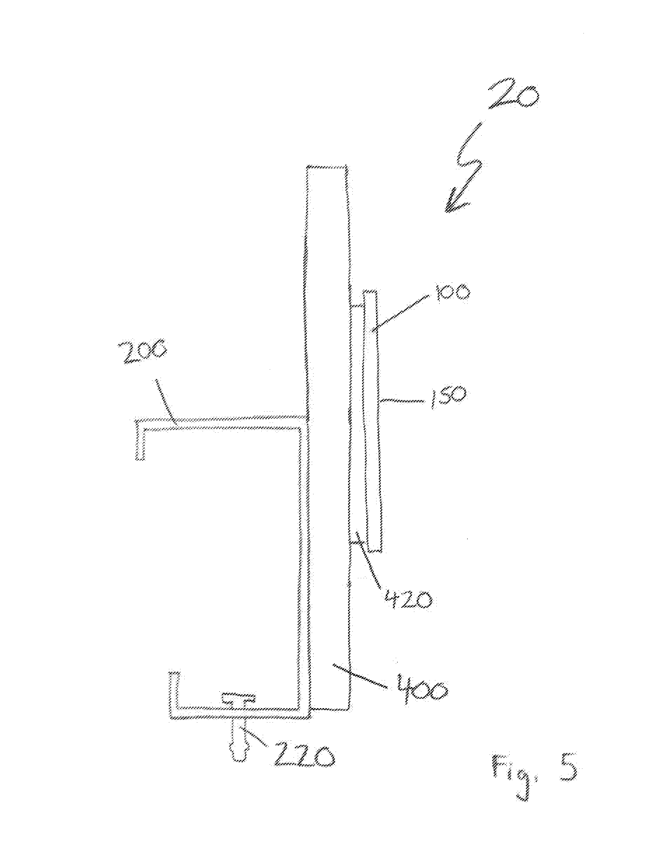

Turning attention to FIGS. 4-5, a second embodiment of a weld observation device, weld observation device 20, will now be described. Weld observation device 20 includes many similar or identical features to weld observation device 10. Thus, for the sake of brevity, each feature of weld observation device 20 will not be redundantly explained. Rather, key distinctions between weld observation device 20 and weld observation device 10 will he described in detail and the reader should reference the discussion above for features substantially similar between the two weld.

observation devices.

As can be seen in FIG. 5, weld observation device 20 comprises a panel of tinted glass 150, and a frame 100 attached to at least one mount 200 via a rail 400. In the illustrated embodiment, rail 400 is attached to a front face of mount 200. Rail 400 functions to allow frame 100 and tinted glass panel 150 to slide up into position to allow a user to safely observe the operation of the welding machine. Rail 400 further functions to allow frame 100 and tinted glass panel 150 to slide down out of the way to allow access to the welding machine.

As shown in FIG. 4, a caster 420 is attached to the rear face of frame 100. As shown, caster 420 is slidably retained by rail 400. The caster 420 may comprise one or more rollers or may rely on low friction materials to facilitate sliding back and forth within rail 400.

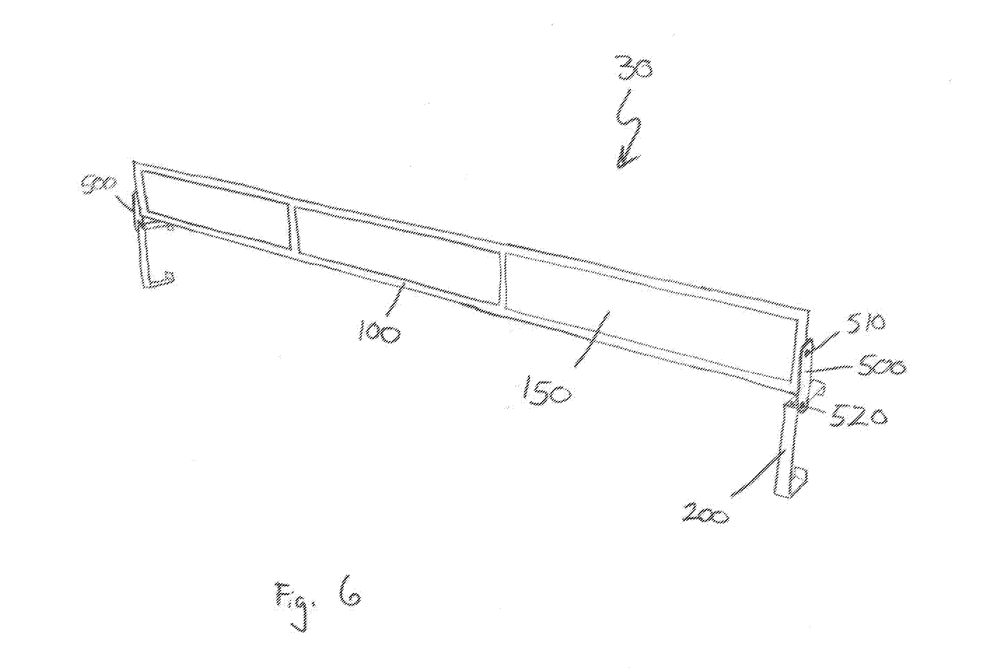

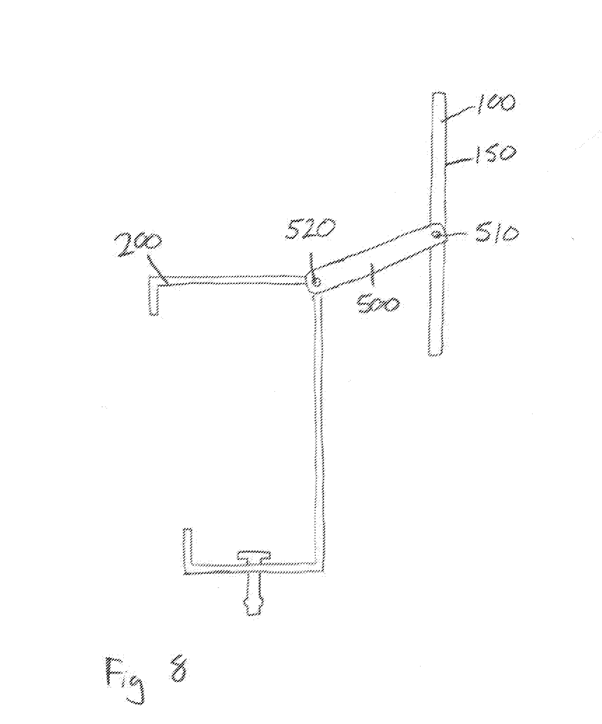

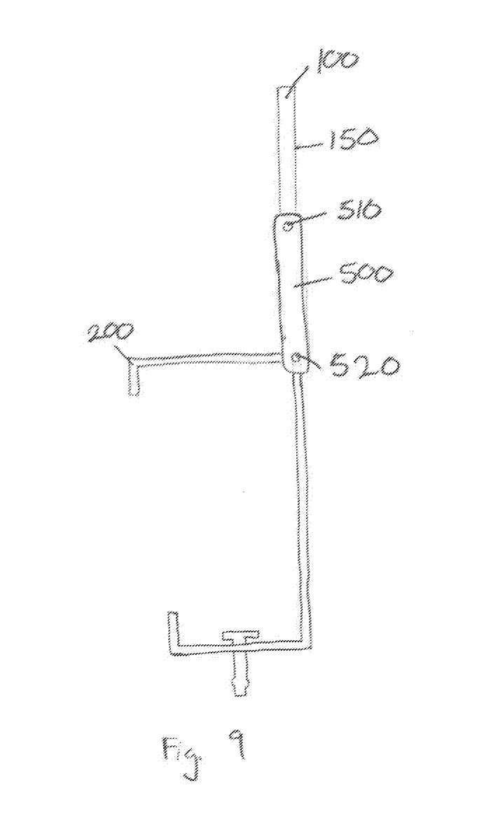

Turning attention to FIGS. 6-9, a third example of a weld observation device, weld observation device 30, will now be described. Weld observation device 30 includes many similar or identical features to weld observation device 10. Thus, for the sake of brevity, each feature of weld observation device 30 will not be redundantly explained. Rather, key distinctions between weld observation device 30 and weld observation device 10 will be descried detail and the reader should reference the discussion above for features substantially similar between the two weld observation devices.

As can be seen in FIG. 6, weld observation device 30 comprises a panel of tinted glass 150, and a frame 100 attached to at least one mount 200 via a pivot arm 500. In the illustrated embodiment, pivot arm 500 is attached to an edge of frame 100 via a first pivot 510. Pivot arm 500 is attached to mount 200 via a second pivot.

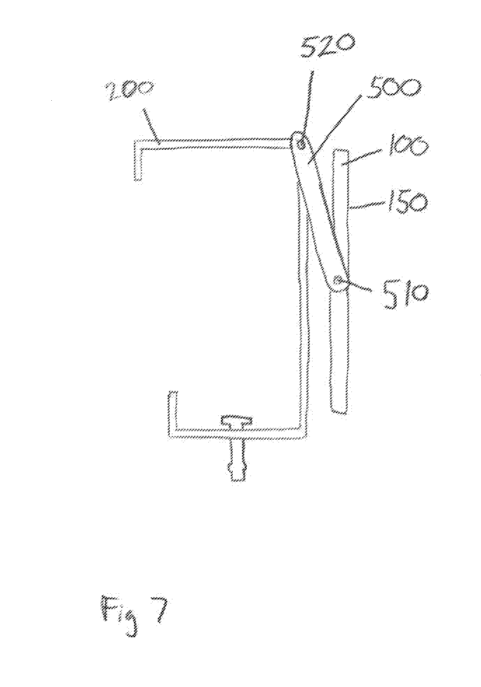

As can be seen in FIGS. 7-9, pivot arm 500 functions to allow frame 100 and tinted glass panel 150 to swing up into position to allow a user to safely observe the operation of the welding machine. Pivot arm 500 further functions to allow frame 100 and tinted glass panel 150 to swing out of the way to allow access to the welding machine.

The disclosure above encompasses multiple distinct inventions with independent utility. While each of these inventions has been disclosed in a particular form, the specific embodiments disclosed and illustrated above are not to be considered in a limiting sense as numerous variations are possible. The subject natter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combination and subcombinations of the disclosed inventions that are believed to be and non-obvious. Inventions embodied in other combinations and subcombinations of features, functions, elements and/or properties may be claimed through amendment of those claims or presentation of new claims the present application or in a related application. Such amended or new claims, whether they are directed to the same invention or a different invention and whether they are different, broader, narrower or equal in scope to the original claims, are to be considered within the subject matter of the inventions describe herein.

1. A device comprising:
a panel of tinted glass
wherein the panel is elongate in the horizontal direction; and
wherein the panel has a perimeter;
a frame secured to at least a portion of perimeter of the panel of tinted glass;
a first mount having an upper surface, wherein the upper surface of the mount is rotatably secured to a bottom edge of the frame via a first hinge;
a first stop bracket attached to the frame such that rotation of the hinge in a first direction is arrested by the stop bracket contacting the upper surface of the mount.

2. The device of claim 1, comprising a pad attached to a front surface of the mount such that rotation of the hinge in a second direction is arrested by the panel of glass contacting a front face of the frame.

3. The device of claim 1, comprising:
a second mount secured to the bottom edge of the frame via a second hinge.

4. The device of claim 1, wherein the tinted glass is tinted to an ANSI welding shade number of from 3 to 14.

5. The device of claim 1, wherein the tinted glass is tinted to an ANSI welding shade number of from 5 to 13.

6. The device of claim 1, wherein the tinted glass is tinted to an ANSI welding shade number of from 7 to 11.

7. The device of claim 1, wherein the tinted glass is tinted to an ANSI welding shade number of from 8 to 10.

8. The device of claim 1, wherein the mount comprises a clamp.

9. The device of claim 8, wherein the clamp comprises a lower clamping jaw spaced apart from an upper clamping jaw.

10. A device comprising:
a panel of tinted glass
wherein the panel is elongate in the horizontal direction; and
wherein the panel has a perimeter;
a frame secured to at least a portion of perimeter of the panel of tinted glass;
a caster attached to a rear face of the frame;
a vertical rail, wherein the rail slideably retains the caster;
a first mount having a front face, wherein the rail s attached to the front face of the first mount.

11. The device of claim 10, wherein the tinted glass is tinted to an ANSI welding shade number of from 3 to 14.

12. The device of claim 10, wherein the mount comprises a clamp.

13. The device of claim 12, wherein the clamp comprises a lower clamping jaw spaced apart from an upper clamping jaw.

14. A device comprising:
a panel of tinted glass
wherein the panel is elongate in the horizontal direction; and
wherein the panel has a perimeter;
a frame secured to at least a portion of perimeter of the panel of tinted glass;
a first mount having an upper surface, wherein the upper surface of the mount is rotatably secured to a side edge of the frame via a first pivot arm.

15. The device of claim 10, wherein the tinted glass is tinted to an ANSI welding shade number of from 3 to 14.

16. The device of claim 10, wherein the mount comprises a clamp.

17. The device of claim 12, wherein the clamp comprises a lower clamping jaw spaced apart from an upper clamping jaw.
